(19) United States
(12) Patent Application Publication
(10) Pub. No.: US 2017/0245541 A1
(43) Pub. Date: Aug. 31, 2017

(54) COMBINATION HERB HOLDER AND GRINDER SYSTEM

(71) Applicant: Michael Pagan, Studio City, CA (US)

(72) Inventor: Michael Pagan, Studio City, CA (US)

(21) Appl. No.: 15/298,652

(22) Filed: Oct. 20, 2016

Related U.S. Application Data
(60) Provisional application No. 62/243,928, filed on Oct. 20, 2015.

(51) Int. Cl. A24B 7/00; A24F 23/00; A24F 17/00; B02C 7/04

(52) U.S. Cl. CPC A24B 7/00; B02C 7/04; A24F 23/00; A24F 17/00

(57) ABSTRACT

The invention features device for grinding and storing herbs and tobacco having a grinder and dispenser that grinds and dispenses the herbs and also holds the herbs and its paraphernalia. The device features storage compartments to hold herb paraphernalia. Release mechanisms such as a push button, slider or aperture allow the herbs to be dispensed directly into rolling paper for immediate use.

### CROSS-REFERENCE TO RELATED APPLICATIONS

This Application claims the benefit of, and is related to, the following Applicant's provisional patent application: U.S. Provisional Patent Application No. 62/243,928 titled “COMBINATION HERB HOLDER AND GRINDER SYSTEM” filed Oct. 20, 2015, which is incorporated herein in its entirety.

### FIELD OF THE INVENTION

The present invention relates, in general, to an herb holder having a grinder and dispenser that grinds and dispenses the herbs and also holds the herbs and its paraphernalia.

### BACKGROUND OF THE INVENTION

Different attempts have been made to grind and store herbs such as tobacco. However, these attempts have not been wholly successful in grinding efficiently and effectively. Current containers in the market do not properly store and transport the herbs to maintain its quality.

Herbs are smoked primarily for medicinal or recreational purposes. It is required that the herbs be grinded so they can be rolled into a paper and smoked. Users need to store the leaves in a manner for freshness and potency in order to maintain its quality. Paraphernalia such as a rolling papers and rolling accessories, is typically stored separate and often difficult to locate when needed.

### SUMMARY OF THE INVENTION

The present invention provides a combination grinder and storage device for herbs and paraphernalia. The invention features a grinder to grind tobacco, herbs, for example. The grinder includes a dispenser and funnel. The bottom portion of the device can disengage and have openings to hold the herb paraphernalia such as rolling paper and rolling paper accessories.

The present invention provides a herbal holder and grinder that can store everything needed for a smoke in a compact unit. The device can grind herbs, store them and dispense them. The device can store smoking paraphernalia, making it efficient and easy to smoke when desired.

An aspect of an embodiment of the present invention contemplates a combination grinder and storage device which may include a cap section, a grinder section, detachably screwed to the cap section, where the grinder section may include a top section and a bottom section, where the top grinder section is detachably screwed to the cap section, where the bottom grinder section may include one or more fenestrations, a funnel section, detachably screwed to the bottom grinder section, and below the one or more fenestrations of the bottom grinder section, where the funnel section may include an aperture at the funnel section's apex, an intermediate section detachably positioned below the funnel section and having an aperture release mechanism, the release mechanism being positioned between the aperture and a storage section below the intermediate section, where the release mechanism may be used to control the flow of ground content into the storage compartment when the release mechanism is in its open position and a container section, fully enclosing the storage section.

In an aspect of an embodiment of the present invention, the release mechanism of the combination grinder and storage device may include a sliding trap having a fenestration, where the sliding trap closes the aperture by being slid horizontally into a position to misalign the fenestration with the aperture to block contents within the funnel section from dropping into the storage section.

In an aspect of an embodiment of the present invention, the release mechanism of the combination grinder and storage device may include a sliding trap having a fenestration, where the sliding trap opens the aperture by being slid horizontally into a position to line the fenestration with the aperture to enable contents within the funnel section drop into the storage section. In an aspect of an embodiment of the present invention, the sliding trap may be sprung into the open position by a spring at an interior end of the sliding trap.

In an aspect of an embodiment of the present invention, the storage section of the combination grinder and storage device may include one or more storage compartments. In an aspect of an embodiment of the present invention, the one or more storage compartments may include one or more apertures sized to receive any one or more of: a lighter, rolling paper, rolled herbs, and other herb paraphernalia.

In an aspect of an embodiment of the present invention, the bottom of the container section may feature foldable legs to support the device. In another aspect of an embodiment of the present invention, the bottom of the container section may feature a self-supporting flat bottom enabling the device to be balanced on this flat bottom. In another aspect of an embodiment of the present invention, the bottom of the container section may be structurally configured to fit into a stand to support the device. In yet another aspect, the container section may include a weight used to balance the device.

In an aspect of an embodiment of the present invention, the combination grinder and storage device may include a grater section disposed between the bottom grinder section and the funnel. The grater section may include a top and bottom grater.

In an aspect of an embodiment of the present invention, the top and bottom grinder section may include a plurality of oppositely positioned grinding members for grinding herbs.

In an aspect of an embodiment of the present invention, the bottom grinder section may include a plurality of holes. These holes enable the ground herbs to fall or drop into the funnel section.

In an aspect of an embodiment of the present invention, the container section may include a set of legs for balancing the device on a surface. In another aspect of an embodiment of the present invention, the set of legs may be folded out from the container section.

Additional aspects, objectives, features and advantages of the present invention will become apparent from the following description of the preferred embodiments with reference to the attached drawings.

### BRIEF DESCRIPTION OF THE DRAWINGS

FIG. 1 illustrates a perspective view of the parts of a grinder and storage device according to an aspect of an embodiment of the present invention.

FIG. 2A illustrates side view of a grinder and storage device cap according to aspects of embodiments of the present invention.

FIG. 2B illustrates a top view of a grinder and storage device cap according to aspects of embodiments of the present invention.

FIG. 2C illustrates a perspective view of a grinder and storage device cap according to aspects of embodiments of the present invention.

FIG. 3A-1 illustrates a top grinder section of a grinder and storage device according to an aspect of an embodiment of the present invention.

FIG. 3A-2 illustrates a top grinder section side view of a grinder and storage device according to an aspect of an embodiment of the present invention.

FIG. 3A-3 illustrates a top grinder section collar of a grinder and storage device according to an aspect of an embodiment of the present invention.

FIG. 3A-4 illustrates a top grinder section perspective view of a grinder and storage device according to an aspect of an embodiment of the present invention.

FIG. 3A-5 illustrates a top grinder section collar perspective view of a grinder and storage device according to an aspect of an embodiment of the present invention.

FIG. 3B-1 illustrates a bottom grinder section of a grinder and storage device showing a top view of fenestrations according to an aspect of an embodiment of the present invention.

FIG. 3B-2 illustrates a bottom grinder section of a grinder and storage device according to an aspect of an embodiment of the present invention.

FIG. 3B-3 illustrates a bottom grinder section of a grinder and storage device showing a top view of fenestrations and grinding members according to an aspect of an embodiment of the present invention.

FIG. 3B-4 illustrates a bottom grinder section of a grinder and storage device showing a perspective view of fenestrations and grinding members according to an aspect of an embodiment of the present invention.

FIG. 4A illustrates a side perspective view funnel section of a grinder and storage device according to an aspect of an embodiment of the present invention.

FIG. 4B illustrates a bottom perspective view funnel section of a grinder and storage device according to an aspect of an embodiment of the present invention.

FIG. 4C illustrates a top perspective view funnel section of a grinder and storage device according to an aspect of an embodiment of the present invention.

FIG. 5A illustrates a middle or intermediate section of a grinder and storage device according to an aspect of an embodiment of the present invention.

FIG. 5B illustrates a top view of a middle or intermediate section a grinder and storage device according to an aspect of an embodiment of the present invention.

FIG. 5C illustrates a perspective view of a top view of a middle or intermediate section of a grinder and storage device according to an aspect of an embodiment of the present invention.

FIG. 6A illustrates a side view of a storage section of a grinder and storage device according to an aspect of an embodiment of the present invention.

FIG. 6B illustrates a top view of a storage section of a grinder and storage device according to an aspect of an embodiment of the present invention.

FIG. 6C illustrates a perspective view of a storage section of a grinder and storage device according to an aspect of an embodiment of the present invention.

FIG. 7A illustrates a side view of a container section of a grinder and storage combination device according to an aspect of an embodiment of the present invention.

FIG. 7B illustrates a bottom view of a container section of a grinder and storage combination device according to an aspect of an embodiment of the present invention.

FIG. 7C illustrates a perspective view of a container section of a grinder and storage combination device according to an aspect of an embodiment of the present invention.

FIG. 8A illustrates a balancing weight used with a grinder and storage combination device according to an aspect of an embodiment of the present invention.

FIG. 8B illustrates a bottom view of a balancing weight used with a grinder and storage combination device according to an aspect of an embodiment of the present invention.

FIG. 8C illustrates a perspective view of a balancing weight used with a grinder and storage combination device according to an aspect of an embodiment of the present invention.

FIG. 9A illustrates a container section of a grinder and storage combination device according to an aspect of an embodiment of the present invention.

FIG. 9B illustrates a top view of a container section of a grinder and storage combination device according to an aspect of an embodiment of the present invention.

FIG. 9C illustrates a perspective view of a container section of a grinder and storage combination device according to an aspect of an embodiment of the present invention.

FIG. 10A-1 illustrates a side view with a top grater section according to an aspect of an embodiment of the present invention.

FIG. 10A-2 illustrates a top view with a top grater section according to an aspect of an embodiment of the present invention.

FIG. 10A-3 illustrates a perspective view with a top grater section according to an aspect of an embodiment of the present invention.

FIG. 10B-1 illustrates a side view with a bottom grater section according to an aspect of an embodiment of the present invention.

FIG. 10B-2 illustrates a top view with a bottom grater section according to an aspect of an embodiment of the present invention.

FIG. 10B-3 illustrates a perspective view with a bottom grater section according to an aspect of an embodiment of the present invention.

### DETAILED DESCRIPTION OF THE INVENTION

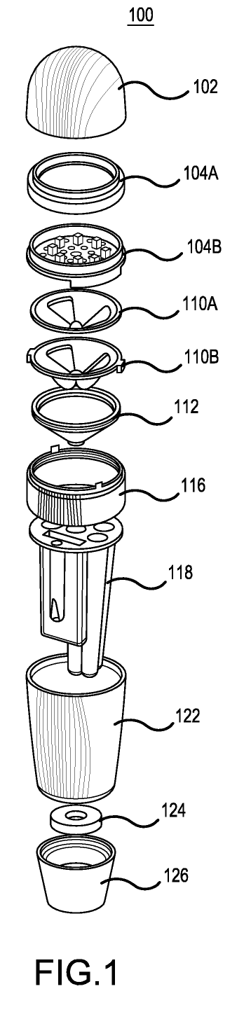

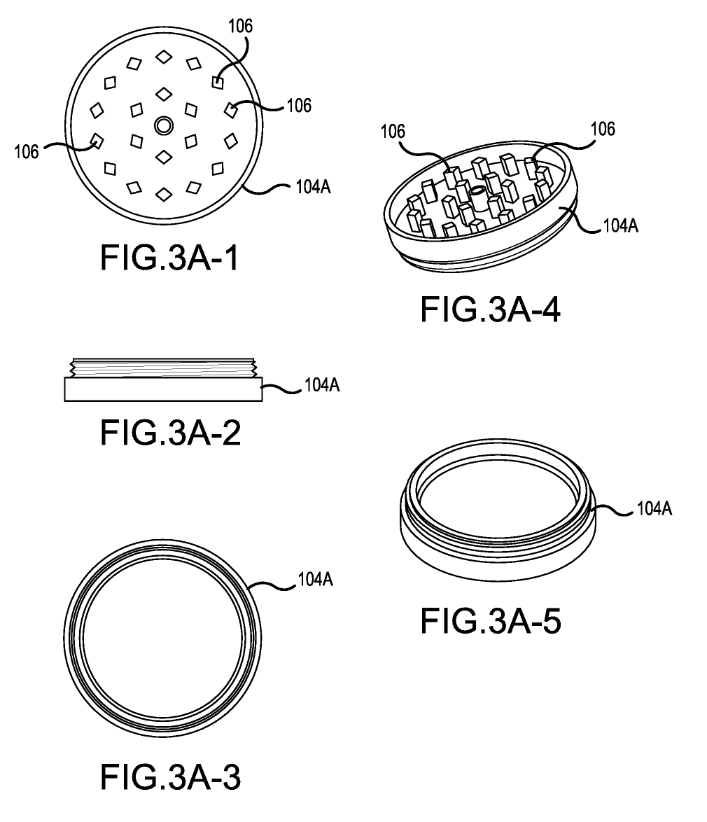

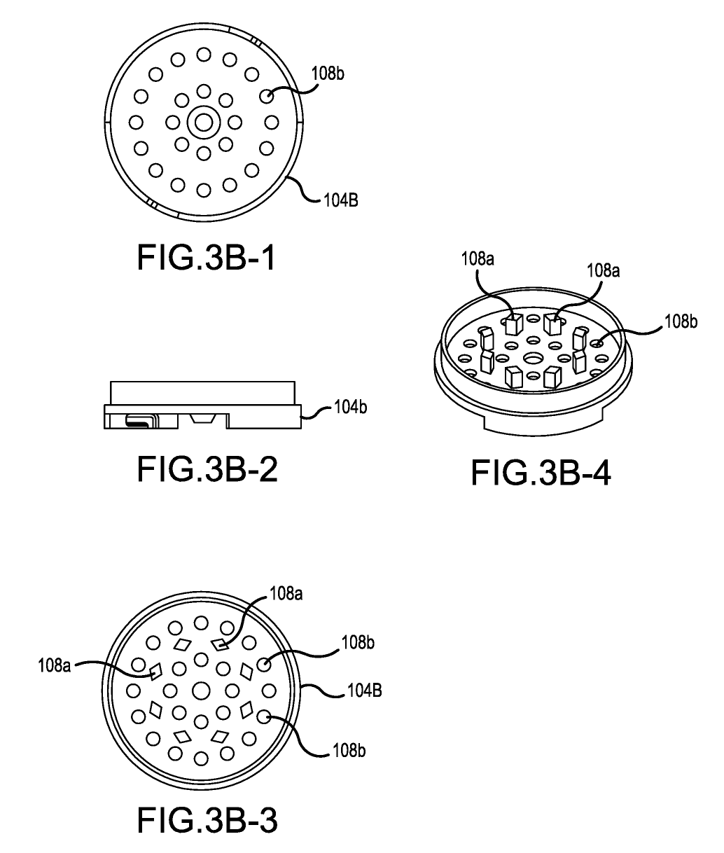

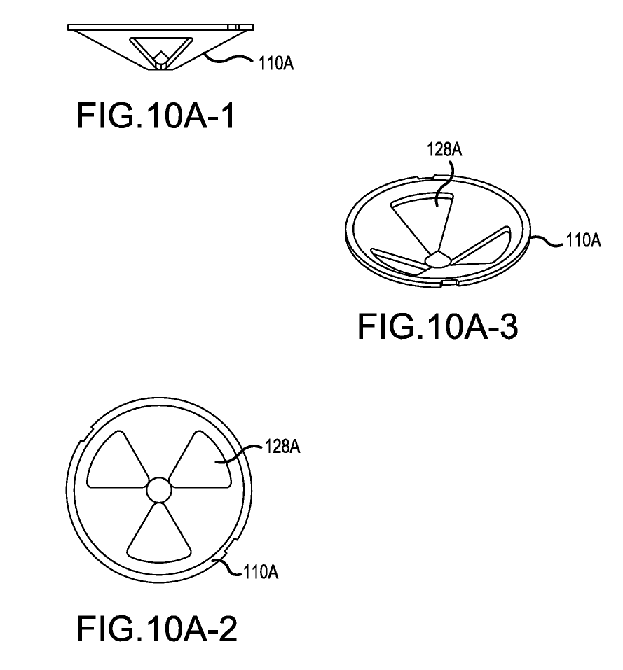

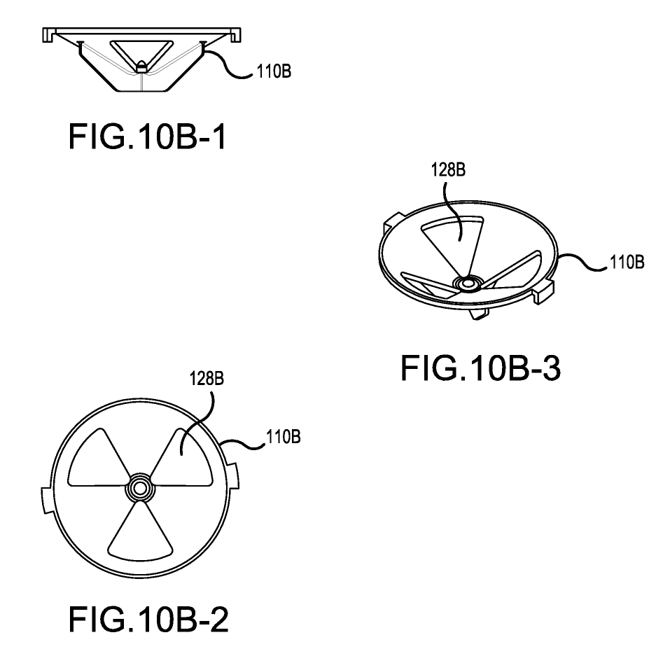

Referring now to FIGS. 1-10B-3, a grinder and storage device 100 and its constituent parts 102-126 are shown according to aspects of embodiments of the present invention. Grinder and storage device 100 may include parts 102-126 (FIG. 1) which may be arranged as shown. Aspects of embodiments of the present invention contemplate grinder and storage device 100 omitting and being able to function without certain parts such as grater sections 110A and 110B.

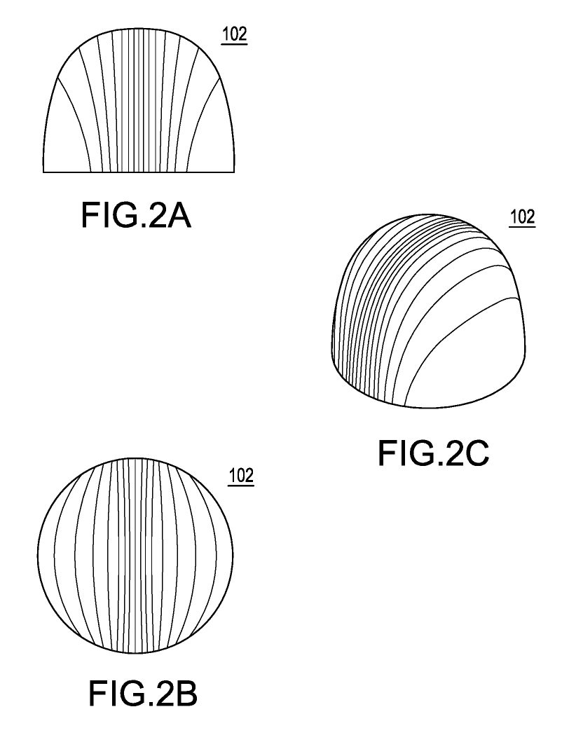

Grinder and storage device 100 may have a top cap 102 (FIGS. 2A, 2B AND 2C) which covers grinder section 104. In an aspect of an embodiment of the present invention cap 102 may be a clear top surface. The clear surface of cap 102 allows a clear view into the grinder. A user can grind the herbs to the desired sized and view the herbs in the grinder without having to open the device. Cap 102 may be, in an aspect of an embodiment of the present invention, screwed, snapped or fitted onto the top of the grinder and storage device 100. Specifically, cap 102 may be screwed, snapped or fitted onto the top of grinder 104. In an aspect of an embodiment of the present invention, cap 102 may be a see-through lid top, enabling a user to see the herbs in the grinder section.

In an aspect of an embodiment of the present invention, cap 102 may include a number of fins on the outer and inner top portion of the device that assist in grinding. In one aspect, the fins that surround cap 102 can be used to push and scoop the herbs and even cut them finer, if desired.

Under cap 102 is grinder section 104 which includes top grinder section 104A and bottom grinder section 104B, as shown in FIGS. 3A-1, 3A-2, 3A-3, 3A-4, 3A-5 and 3B-1, 3B-2, 3B-3, and 3B-4. In an aspect of an embodiment of the present invention, top grinder section 104A may include a plurality of grinding members 106. These members may be arranged in different positions including, without limitation, positions that are angular and perpendicular to the surface of top grinding section 104A. In an aspect of an embodiment of the present invention, they may have different shapes. In another aspect, they may have the same shape. In an aspect of an embodiment of the present invention, the top of top grinder section 104A may have a see-through top to enable a user to view the herbs as they are being ground.

In an aspect of an embodiment of the present invention, bottom grinder section 104B may include a plurality of grinding members 108a. These members may be arranged in different positions including, without limitation, positions that are angular and perpendicular to the surface of top grinding section 104B. In an aspect of an embodiment of the present invention, they may have different or the same shape. Grinding members 106 and 108 cooperate, during grinding operation of grinding and storage device 100, to grind herbs placed within grinder section 104.

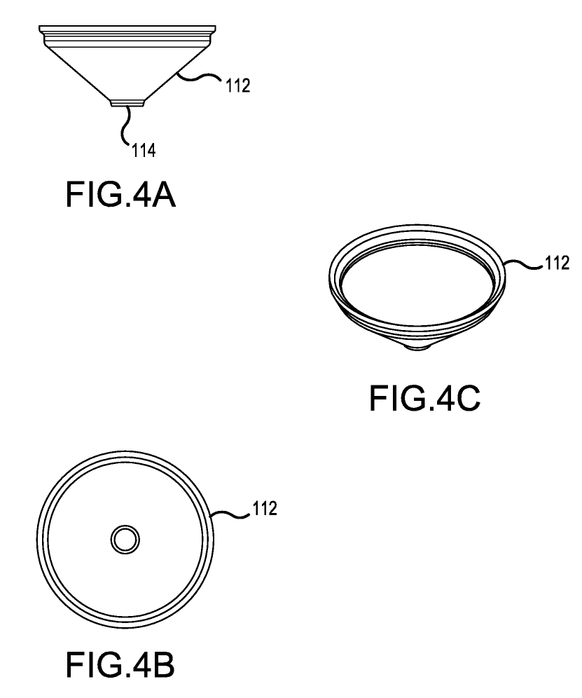

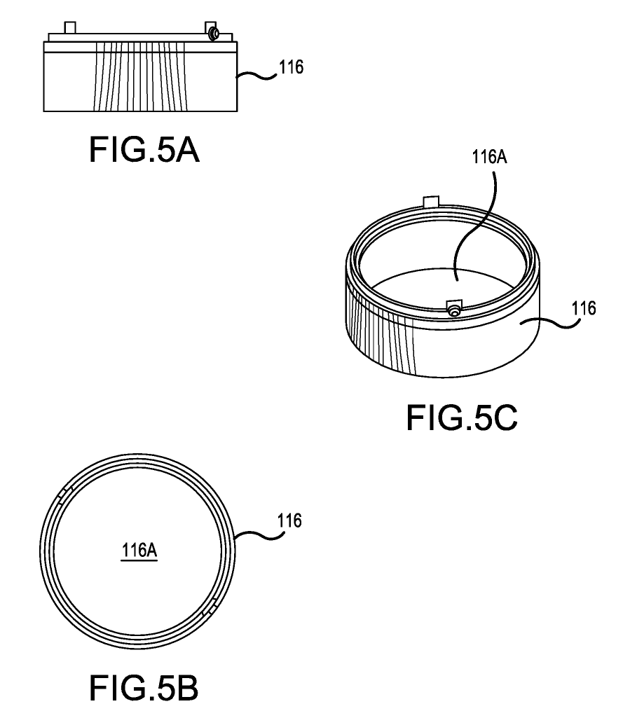

Bottom grinding section 104B may also include a plurality of fenestrations 108b that enable ground herbs to drop into funnel section 112 of grinding and storage device 100, as shown in FIGS. 4A, 4B and 4C. Funnel section 112, in an aspect of an embodiment of the present invention, may be detachably positioned under bottom grinder section 104B. Funnel section 112 may include aperture 114 at the apex of funnel section 112. Aperture 114 provides the outlet for ground herbs to pass through funnel section 112 into the next section of grinding and storage device 100. In an aspect of an embodiment of the present invention, funnel section 112 may be screwed onto intermediate section 116 (FIGS. 5A, 5B and 5C).

Intermediate section 116 may include, in one aspect of an embodiment of the present invention, a chamber 116A for receiving the ground herbs and an aperture release mechanism 116B, which controls the flow of ground herbs through intermediate section 116 and into storage section 118. In an aspect of an embodiment of the present invention, aperture release mechanism 116B may be a sliding trap having a fenestration, where the sliding trap closes aperture 114 by being slid horizontally into a position to misalign the fenestration with aperture 114 to block contents within funnel section 112 from dropping into storage section 118. In an aspect of an embodiment of the present invention, the sliding trap of aperture release mechanism 116B opens aperture 114 by being slid horizontally into a position to line the sliding trap's fenestration with aperture 114 to enable contents within funnel section 112 drop into storage section 118.

In an aspect of an embodiment of the present invention, aperture release mechanism 116B (such as, without limitation, a sliding trap) is inserted through a side opening on device 100 so that the trap is aligned directly below aperture 114. The trap 116B will prevent ground herbs from falling through aperture 114 by closing the aperture. The user can control the quantity of herbs to be stored by sliding the trap in a horizontal direction to open and close aperture 114. When the trap is slid away from the device, herbs fall through aperture 114. When the trap is slid towards the device, the user can control the quantity of herbs to be moved to storage section 118 or directly onto a separate rolling paper positioned within one of storage section 118's compartments 120.

In an aspect of an embodiment of the present invention, aperture release mechanism 116B may be a spring-loaded push button which moves a fenestration into position to allow ground herbs to drop into storage section 118. In one aspect, the push button may extend outward from grinding and storage device 100.

In one aspect of an embodiment of the present invention, aperture release mechanism 116B may be a foolproof pull tab which, when pulled outwards away from grinding and storage device 100, aligns its fenestration with aperture 114, thereby allowing ground herbs to drop into storage section 118. The pull tab may have a solid area that prevents the herbs from entering into storage section 118.

In other aspects of embodiments of the present invention, aperture release mechanism 116B may be any one of a push release mechanism, sliding mechanism or a pull-out mechanism all having fenestrations which, when aligned with aperture 114, allow ground herbs to drop into storage section 118. In one aspect, the push release feature when pushed in, its opening aligns with the grinder opening and the herbs move from aperture 114 through the push release opening.

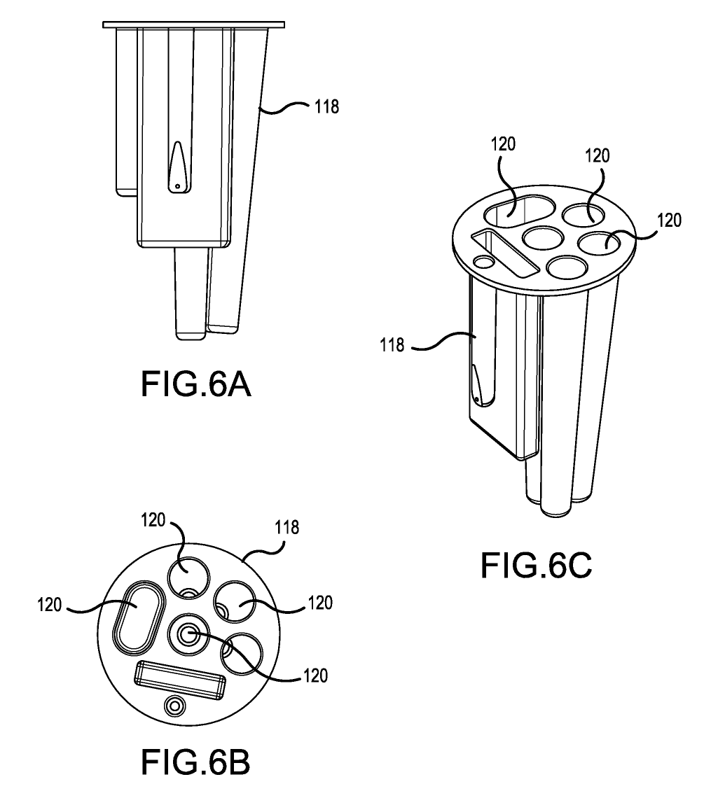

Referring now to FIGS. 6A, 6B, and 6C, a storage section 118 of grinding and storage device 100, is shown. Storage section 118 may comprise of one or more storage compartments 120 into which ground herbs dropping from funnel section 112 (through intermediate section 116) may be captured. In an aspect of an embodiment of the present invention, storage compartments 120 may have varying shapes configured to hold extra herbs and/or a variety of paraphernalia such as paper, lighters, cones, a pack pin, paper storage etc. These features keep all of the paraphernalia at the fingertips of the user. In another aspect, pistons may be fitted inside of storage compartment 120 to receive the herbs. Rolling papers may be positioned in the pistons so that when the herbs fall into the papers, the papers can be removed for immediate smoking.

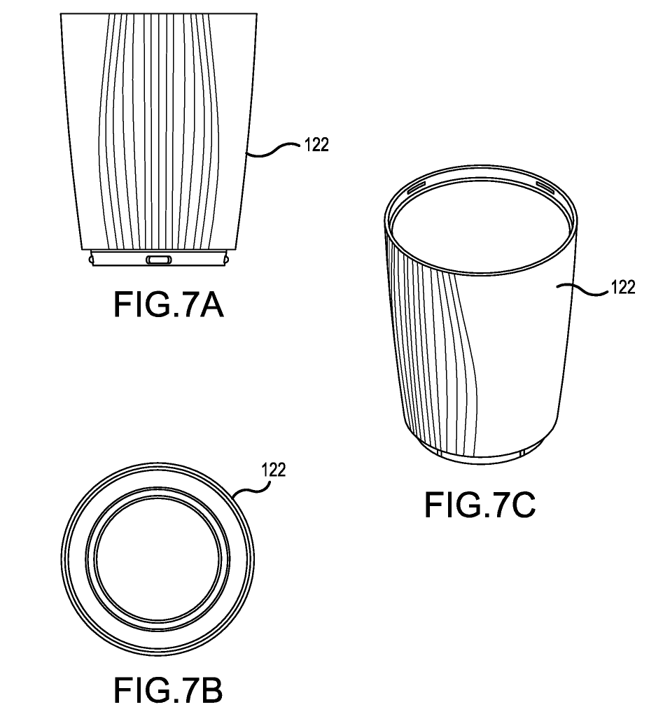

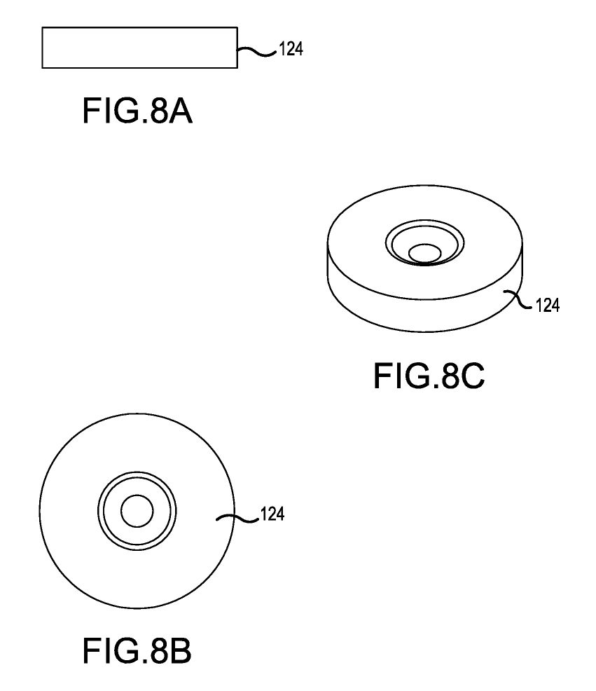

Grinding and storage device 100 may include container section 122 (FIGS. 7A, 7B and 7C). Storage section 118 may fit and be detachably placed within container section 122. Storage section 118 may be positioned within container section 122 using clips, magnets or the like. Container section 122 may, in one aspect of an embodiment of the present invention, be connected with intermediate section 116. To balance grinding and storage device 100, a weight 124, shown in FIGS. 8A, 8B, and 8C, may be used and placed at the base of container section 122.

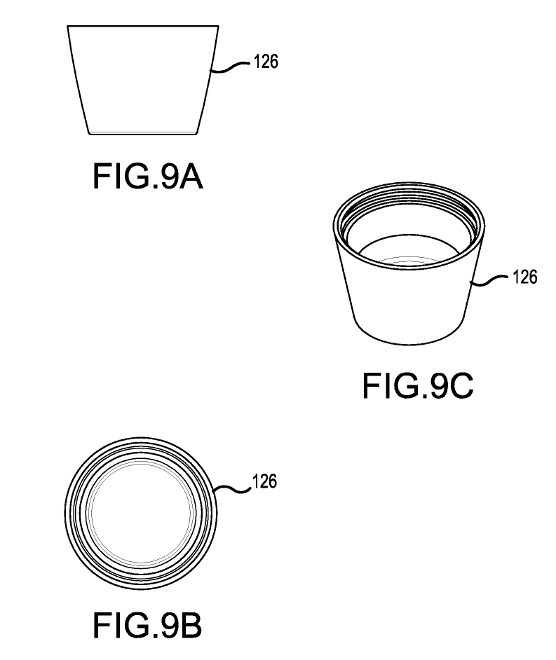

In an aspect of an embodiment of the present invention, container section 122 may include a bottom cap 126, shown in FIGS. 9A, 9B and 9C, which may be screwed to the base of container section 122. In one aspect, this may be made possible using standard course threading.

In another aspect of an embodiment of the present invention, container section 122 may include a number of fold down legs (not shown) which may be folded out to enable device 100 to be balanced and placed on a surface. The legs may be integrated into container section 122 of device 100 and can be unfolded to support the device. Alternatively, the device can fit inside of a stand.

In another aspect of an embodiment of the present invention, grinding and storage device 100 may include grater section 110 (FIGS. 10A-1, 10A-2, 10A-3, 10B-1, 10B-2 and 10B-3) detachably positioned between bottom grinding section 104B and funnel section 112. Grater section 110 may comprise of a top grater section 110A and a bottom grater section top. Each of the grater sections may include sweeper apertures 124A and 124B for the top and bottom grater section. Sweeper apertures 124A and 124B are used to sweep ground herbs into storage compartments 120 which may have paper placed in each to capture the ground herbs. Grater section 110 may, in one aspect, be operated using an external lever (not shown) to rotate and guide the ground herbs into the storage section 118 (and consequently storage compartments 120).

When closed, sweeper apertures 124A are blocked by a similar part of bottom grater section 110B positioned underneath sweeper apertures 124A. As bottom grater section 110B is spun, when sweeper apertures 124A and 124B line up the ground material may then fall down into the funnel and into the cone paper when the storage section 118 is not attached to funnel section 112.

Once the herbs are placed into grinder section 104, the user can grind the herbs mechanically by, in one aspect of an embodiment of the present invention, by rotary motion of cap 102 and grinder section 104. In another aspect, grinder section 104 may be automated—whereby it may begin the grinding process once herbs are detected within grinder section 104. Once ground, the herbs will fall through aperture 114 into storage section 118 or directly onto a separate rolling paper or wherever desired by the user.

In an aspect of an embodiment of the present invention, the grinding and storage device 100 may include a group of valves that pull upward. The valves may be positioned in storage section 118, and may be sized to receive the herbs. Apertures may be positioned above the valves so as the herbs are grinded, they fall through the apertures into the valves. The valves are pulled upwards to remove them from storage section 118 and the herbs can be easily removed from the valves.

Aspects of embodiments of the present invention contemplate grinder and storage combination device 100 having multiple shapes, sizes and colors. Certain designs contemplate having top portions of device 100 being capable of turning in a clockwise or counterclockwise direction to activate the grinder.

Aspects of embodiments of the present invention contemplate grinder and storage combination device 100 having contoured sides. The contoured sides provide ease in grasping the device. Also, the device can be contoured to easily fit into a pocket of the user and not look bulky in the pocket.

In an aspect of an embodiment of the present invention, grinding and storage device 100 may have a textured grip on its surface for ease in holding the device. It may also be made from an anodized aluminum or ABS. Different aspects contemplate different shapes and sizes for grinding and storage device 100.

In an aspect of an embodiment of the present invention, grinding and storage device 100 may have a flat bottom. In another aspect, storage section 118 may connect with grinder section 104 using strong magnets, screws or other known securing mechanism.

The invention has been described in detail with particular reference to certain preferred embodiments thereof, but it will be understood that variations and modifications can be effected within the spirit and scope of the invention.

What is claimed is:

1. A combination grinder and storage device comprising:
a cap section;
a grinder section, detachably screwed to the cap section, wherein the grinder section comprises of a top section and a bottom section, wherein the top grinder section is detachably screwed to the cap section, wherein the bottom grinder section comprises of at least one fenestration;
a funnel section, detachably screwed to the bottom grinder section, and below the at least one fenestration of the bottom grinder section, wherein the funnel section comprises of an aperture at the funnel section's apex;
an intermediate section detachably positioned below the funnel section and having an aperture release mechanism, the release mechanism being positioned between the aperture and a storage section below the intermediate section, wherein the release mechanism enables flow of ground content into the storage compartment when the release mechanism is in its open position; and
a container, fully enclosing the storage section.

2. The combination grinder and storage device of claim 1, wherein the release mechanism comprises of a sliding trap having a fenestration, wherein the sliding trap closes the aperture by being slid horizontally into a position to misalign the fenestration with the aperture to block contents within the funnel section from dropping into the storage section.

3. The combination grinder and storage device of claim 1, wherein the release mechanism comprises of a sliding trap having a fenestration, wherein the sliding trap opens the aperture by being slid horizontally into a position to line the fenestration with the aperture to enable contents within the funnel section drop into the storage section.

4. The combination grinder and storage device of claim 3, wherein the sliding trap is sprung into the open position by a spring at an interior end of the sliding trap.

5. The combination grinder and storage device of claim 1, wherein the storage section comprises of at least one storage compartment.

6. The combination grinder and storage device of claim 5, wherein the at least one storage compartment comprises of at least one aperture sized to receive any one or more of: a lighter, rolling paper, rolled herbs, and other herb paraphernalia.

7. The combination grinder and storage device of claim 1, wherein the bottom of the container section features foldable legs to support the device.

8. The combination grinder and storage device of claim 1, wherein the bottom of the container section features a self-supporting flat bottom.

9. The combination grinder and storage device of claim 1, wherein the bottom of the container section is structurally configured to fit into a stand to support the device.

10. The combination grinder and storage device of claim 1 further comprising of a grater section disposed between the bottom grinder section and the funnel.

11. The combination grinder and storage device of claim 1 wherein the top and bottom grinder section comprises of a plurality of oppositely positioned grinding members for grinding herbs.

12. The combination grinder and storage device of claim 1, wherein the bottom grinder section comprises of a plurality of holes.

13. The combination grinder and storage device of claim 1, wherein the container section comprises of a weight used to balance the device.

14. The combination grinder and storage device of claim 1, wherein the container section comprises of a set of legs for balancing the device on a surface.

15. The combination grinder and storage device of claim 14, wherein the set of legs may be folded out from the container section.
